(19) United States
(12) Patent Application Publication
(10) Pub. No.: US 2011/0231167 A1
(43) Pub. Date: Sep. 22, 2011

(54) Inspection Apparatus and Associated Method and Monitoring and Control System

(75) Inventors: Hugo Augustinus Joseph CRAMER, Eindhoven (NL); Patricius Aloysius Jacobus Tinnemans, Hapert (NL)

(73) Assignee: ASML Netherlands B.V., Veldhoven (NL)

(21) Appl. No.: 13/047,185

(22) Filed: Mar. 14, 2011

Related U.S. Application Data
(60) Provisional application No. 61/315,150, filed on Mar. 18, 2010.

(51) Int. Cl. G06F 17/10; G03B 27/54

(52) U.S. Cl. 703/2; 355/67

(57) ABSTRACT

A method, a lithographic apparatus, and a computer-readable medium provide a model of a metrology tool to determine a measurement error and/or covariance of particular parameters, such as the critical dimension and the sidewall angle, of a number of targets, such as gratings. The model can include at least one measurement error source. The method can include using a metrology tool to measure each target and using the model to determine the measurement error of the measured parameters of the particular target when measured by said metrology tool. The value of the measured parameter along with the corresponding measurement error is then determined in the metrology tool output for each particular target, and can be used in exposure focus and dose control in a lithographic process.

### CROSS REFERENCE TO RELATED APPLICATIONS

This application claims benefit under 35 U.S.C. 119(e) to U.S. Provisional Patent Application No. 61/315,150, filed Mar. 18, 2010, which is incorporated by reference herein in its entirety.

### FIELD

Embodiments of the present invention relate to modeling methods usable, for example, in the manufacture of devices by lithographic techniques, as well as associated apparatuses.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., including a portion of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called “steppers,” in which each target portion is irradiated by exposing an entire pattern onto the target portion at one time, and so-called “scanners,” in which each target portion is irradiated by scanning the pattern through a radiation beam in a given direction (the “scanning”-direction) while synchronously scanning the substrate parallel or anti parallel to this direction. It is also possible to transfer the pattern from the patterning device to the substrate by imprinting the pattern onto the substrate.

In order to monitor the lithographic process, parameters of the patterned substrate are measured. Parameters may include, for example, the overlay error between successive layers formed in or on the patterned substrate and critical linewidth of developed photosensitive resist. This measurement may be performed on a product substrate and/or on a dedicated metrology target. There are various techniques for making measurements of the microscopic structures formed in lithographic processes, including the use of scanning electron microscopes and various specialized tools. A fast and non-invasive form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometers are known. Spectroscopic scatterometers direct a broadband radiation beam onto the substrate and measure the spectrum (intensity as a function of wavelength) of the radiation scattered into a particular narrow angular range. Angularly-resolved scatterometers use a monochromatic radiation beam and measure the intensity of the scattered radiation as a function of angle.

Two important parameters of a lithographic apparatus, and specifically of the exposure action that the lithographic apparatus carries out, which may also be measured by scatterometers, are focus and dose. Specifically, a lithographic apparatus has a radiation source, a projection system and an alignment system as mentioned below.

The dose of radiation that is projected onto a substrate in order to expose it is controlled by various parts of the exposure apparatus (of the lithographic apparatus). It is (mainly) the combination of alignment (focus alignment) and the projection system of the lithographic apparatus that is responsible for the focus of the radiation onto the correct portions of the substrate. It is important that the focusing occurs at the level of the substrate, rather than above or below, so that the sharpest image will occur at the level of the substrate and the sharpest pattern possible may be exposed thereon. This enables, for example, smaller product patterns to be printed.

The focus and dose of the radiation directly affect the parameters of the patterns or structures that are exposed on the substrate. Parameters that can be measured using a scatterometer are physical properties of structures that have been printed onto a substrate such as the critical dimension (CD) or sidewall angle (SWA) of, for example, a bar-shaped grating type structure. The critical dimension is effectively the mean width of a structure such as a bar (or a space, dot or hole, depending on the type of the measured structures). The sidewall angle is the angle between the surface of the substrate and the rising (or falling) portion of the structure.

Focus and dose have been determined simultaneously by scatterometry (or scanning electron microscopy) from structures in the mask pattern (which gives rise to target structures on the substrate, from which measurements are taken). The targets can be designed to have high sensitivity of the critical dimension and sidewall angle for focus and dose. Multiple targets with different sensitivities (e.g., a semi isolated structure and a dense grating) may be chosen such that, when exposed and processed, a possibly unique combination of critical dimension and sidewall angle measurements result from each of the targets. If these unique combinations of critical dimension and sidewall angle are available, the focus and dose values can be uniquely determined from these measurements, although there can never be any guarantee that the inversion of critical dimension and sidewall angle to focus and dose has a unique solution.

It is known to use a model to describe the critical dimension and sidewall angle as a function of focus and dose, the model being calibrated using experimental data. With the model, a measured critical dimension and sidewall angle of a target can be converted towards a focus and dose value. Based upon the retrieved focus and dose values, a feedback loop can be used to monitor and/or stabilize the exposure apparatus.

However, such a feedback loop, and the fitting of measurement data from multiple targets, may be optimized by knowledge of the accuracy/uncertainty of the focus and dose measurements. This, in turn, requires knowledge of the uncertainty of the measured sidewall angle and critical dimension parameters. Simply using the stated or measured uncertainty of the metrology tool used to make these measurements is not sufficient since this accuracy is an upper limit, whereas the actual accuracy can be very application dependent. For example, the repeatability for the midCD of a dense line target can be four times better than for a semi isolated target.

### SUMMARY

It is desirable to provide a system which aims to address one or more of the abovementioned issues.

According to an embodiment of the invention, there is provided a method that includes the following: providing a model of a metrology tool, the model comprising at least one measurement error source, using a metrology tool to measure a particular target, using said model to determine the measurement error of at least one measured parameter of said particular target being measured by said metrology tool, and, reporting the value of said at least one parameter along with the corresponding measurement error determined for said at least one parameter, in the metrology tool output for each particular target.

According to a second embodiment of the present invention, there is provided an inspection apparatus being operable to carry out the above method.

According to a third embodiment of the present invention, there is provided a monitoring and control system for a lithographic apparatus being operable to carry out the above method.

According to a fourth embodiment of the present invention, there is provided a computer readable medium comprising program instructions for controlling an inspection and/or lithographic apparatus, said program instructions causing said apparatus to perform the above method.

Further features and advantages of embodiment of the present invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate embodiments of the present invention and, together with the description, further serve to explain the principles of embodiments of the invention and to enable a person skilled in the relevant art(s) to make and use embodiments of the present invention.

FIG. 1a depicts an example lithographic apparatus, which can be used with embodiments of the present invention.

FIG. 1b depicts an example lithographic cell or cluster, which can be used with embodiments of the present invention.

FIG. 2 depicts a first example scatterometer, which can be used with embodiments of the present invention.

FIG. 3 depicts a second example scatterometer, which can be used with embodiments of the present invention.

FIG. 4 depicts a process for modeling a spectrometer, according to an embodiment of the present invention.

FIG. 5 shows a model calibration algorithm block diagram, according to an embodiment of the present invention.

FIG. 6 shows a wafer focus and inversion algorithm block diagram, according to an embodiment of the present invention.

The features and advantages of embodiments of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the relevant art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include the following: read only memory (ROM); random access memory (RAM); magnetic disk storage media; optical storage media; flash memory devices; and, electrical, optical, acoustical signals, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

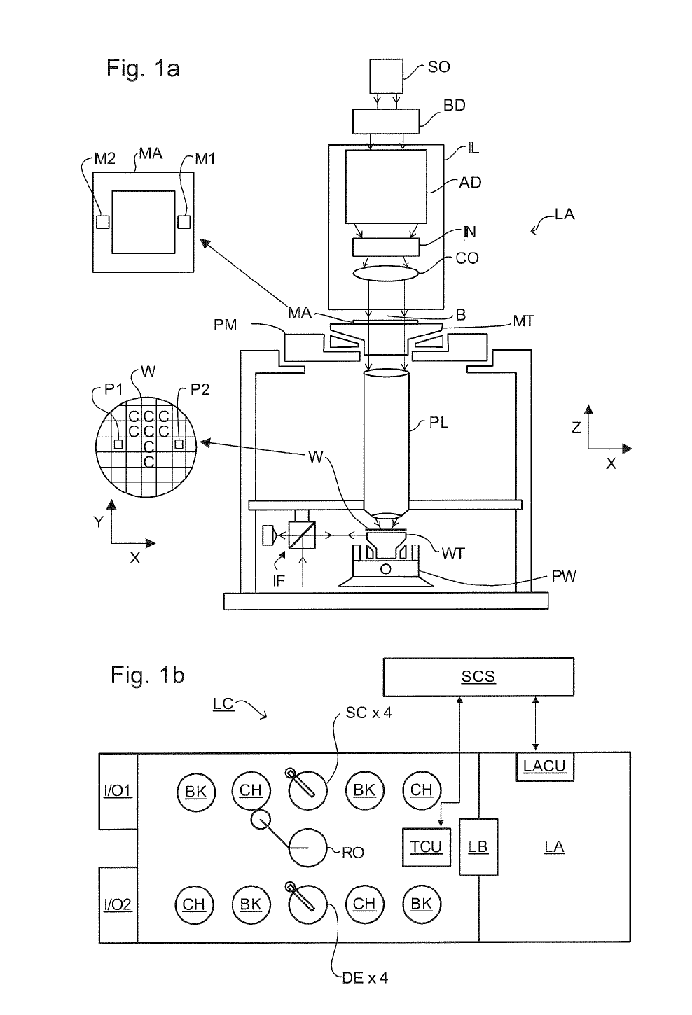

FIG. 1a schematically depicts an example lithographic apparatus, which can be used with embodiments of the present invention. The apparatus includes the following: an illumination system (illuminator) IL configured to condition a radiation beam B (e.g., UV radiation or DUV radiation); a support structure (e.g., a mask table) MT constructed to support a patterning device (e.g., a mask) MA and connected to a first positioner PM configured to accurately position the patterning device in accordance with certain parameters; a substrate table (e.g., a wafer table) WT constructed to hold a substrate (e.g. a resist coated wafer) W and connected to a second positioner PW configured to accurately position the substrate in accordance with certain parameters; and, a projection system (e.g., a refractive projection lens system) PL configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports (i.e., bears the weight of) the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index (e.g., water) so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, is be submerged in liquid, but rather means that liquid is located between the projection system and the substrate during exposure.

Referring to FIG. 1a, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g., an interferometric device, linear encoder, 2-D encoder or capacitive sensor), the substrate table WT can be moved accurately (e.g., so as to position different target portions C in the path of the radiation beam B). Similarly, the first positioner PM and another position sensor (which is not explicitly depicted in FIG. 1a) can be used to accurately position the mask MA with respect to the path of the radiation beam B (e.g., after mechanical retrieval from a mask library, or during a scan). In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as “scribe-lane alignment marks”). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 1b, the lithographic apparatus LA forms part of a lithographic cell LC, also sometimes referred to a lithocell or cluster, which also includes apparatus to perform pre- and post-exposure processes on a substrate. Conventionally, these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers them to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded, thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. However, the latent image in the resist has a very low contrast—where is only a very small difference in refractive index between the parts of the resist which have been exposed to radiation and those which have not—and not all inspection apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

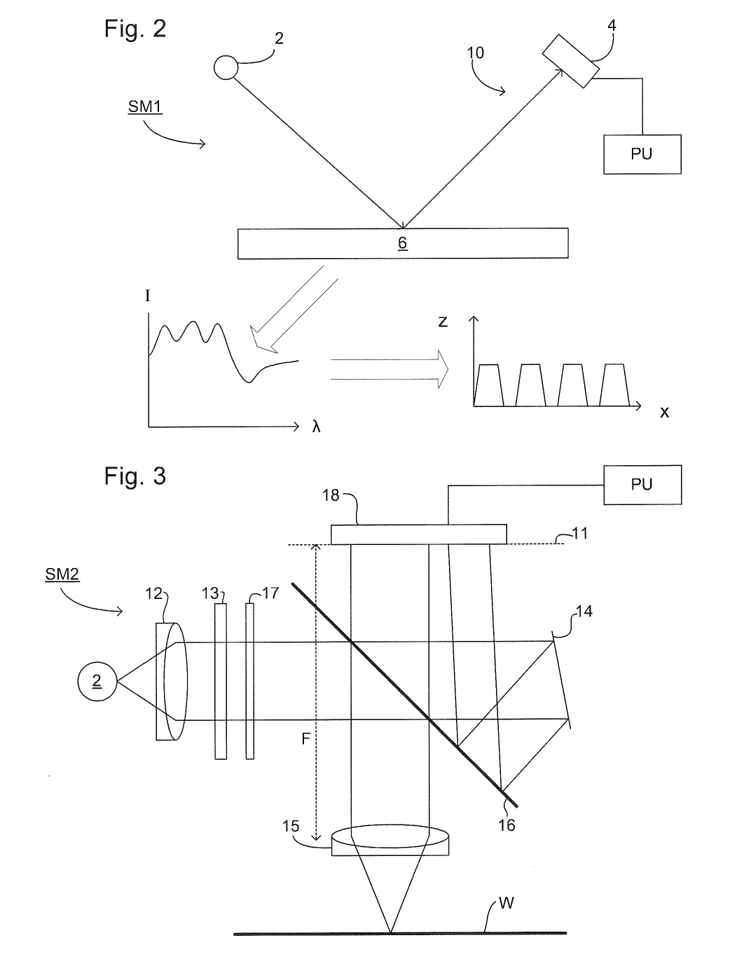

FIG. 2 depicts a scatterometer, which may be used with embodiments of the present invention. It comprises a broadband (white light) radiation projector 2 which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU (e.g., by Rigorous Coupled Wave Analysis and non-linear regression or by comparison with a library of simulated spectra as shown at the bottom of FIG. 2). In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer that may be used with embodiments of the present invention is shown in FIG. 3. In this device, the radiation emitted by radiation source 2 is collimated using lens system 12 and transmitted through interference filter 13 and polarizer 17, reflected by partially reflected surface 16 and is focused onto substrate W via a microscope objective lens 15, which has a high numerical aperture (NA), preferably at least 0.9 and more preferably at least 0.95. Immersion scatterometers may even have lenses with numerical apertures over 1. The reflected radiation then transmits through partially reflecting surface 16 into a detector 18 in order to have the scatter spectrum detected. The detector may be located in the back-projected pupil plane 11, which is at the focal length of the lens system 15; however, the pupil plane may instead be re-imaged with auxiliary optics (not shown) onto the detector. The pupil plane is the plane in which the radial position of radiation defines the angle of incidence and the angular position defines azimuth angle of the radiation. The detector is preferably a two-dimensional detector so that a two-dimensional angular scatter spectrum of a substrate target 30 can be measured. The detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16 part of it is transmitted through the beam splitter as a reference beam towards a reference mirror 14. The reference beam is then projected onto a different part of the same detector 18 or alternatively on to a different detector (not shown).

A set of interference filters 13 is available to select a wavelength of interest in the range of, for example, 405-790 nm or even lower, such as, for example, 200-300 nm. The interference filter may be tunable rather than comprising a set of different filters. A grating could be used instead of interference filters.

The detector 18 may measure the intensity of scattered light at a single wavelength (or narrow wavelength range), the intensity separately at multiple wavelengths or integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e., one with a wide range of light frequencies or wavelengths) is possible, which gives a large etendue, allowing the mixing of multiple wavelengths. The plurality of wavelengths in the broadband preferably each has a bandwidth of Δλ and a spacing of at least 2 Δλ (i.e., twice the bandwidth). Several “sources” of radiation can be different portions of an extended radiation source which have been split using fiber bundles. In this way, angle-resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP1,628,164A, which is incorporated herein by reference in its entirety

The target 30 on substrate W may be a 1-D grating, which is printed such that after development, the bars are formed of solid resist lines. The target 30 may be a 2-D grating, which is printed such that after development, the grating is formed of solid resist pillars or vias in the resist. The bars, pillars or vias may alternatively be etched into the substrate. This pattern is sensitive to chromatic aberrations in the lithographic projection apparatus, particularly the projection system PL, and illumination symmetry and the presence of such aberrations will manifest themselves in a variation in the printed grating. Accordingly, the scatterometry data of the printed gratings is used to reconstruct the gratings. The parameters of the 1-D grating, such as line widths and shapes, or parameters of the 2-D grating, such as pillar or via widths or lengths or shapes, may be input to the reconstruction process, performed by processing unit PU, from knowledge of the printing step and/or other scatterometry processes.

Exposure Focus and Dose can be derived from the measured critical dimension (CD) and sidewall angle (SWA) of one or more targets. The targets used in the methods disclosed herein can be designed such that the critical dimension and sidewall angle are highly sensitive to focus and dose during exposure. A model which describes the critical dimension and sidewall angle as a function of focus and dose is used, being initially calibrated using experimental data. With the model, the measured critical dimension and sidewall angle of a target printed in a production or monitoring process can be converted to a corresponding focus and dose value. To enhance the separation of focus and dose multiple targets with different sensitivities can be used (e.g., a semi isolated and a dense grating). These focus and dose values can often be uniquely determined from these measurements from different targets and also the uncertainty of and the correlation between the focus and dose values can be reported, in the form of a covariance matrix, for example. The values of focus and dose, in turn, can be used in a feedback loop to monitor and/or stabilize exposure. However, this feedback loop and use of multiple targets may be optimized when the measurement uncertainty of the measured critical dimension and sidewall angle is known, or at least can be accurately estimated, thereby allowing the uncertainty of and the correlation between the focus and dose values to be reported, in the form of a covariance matrix, for example.

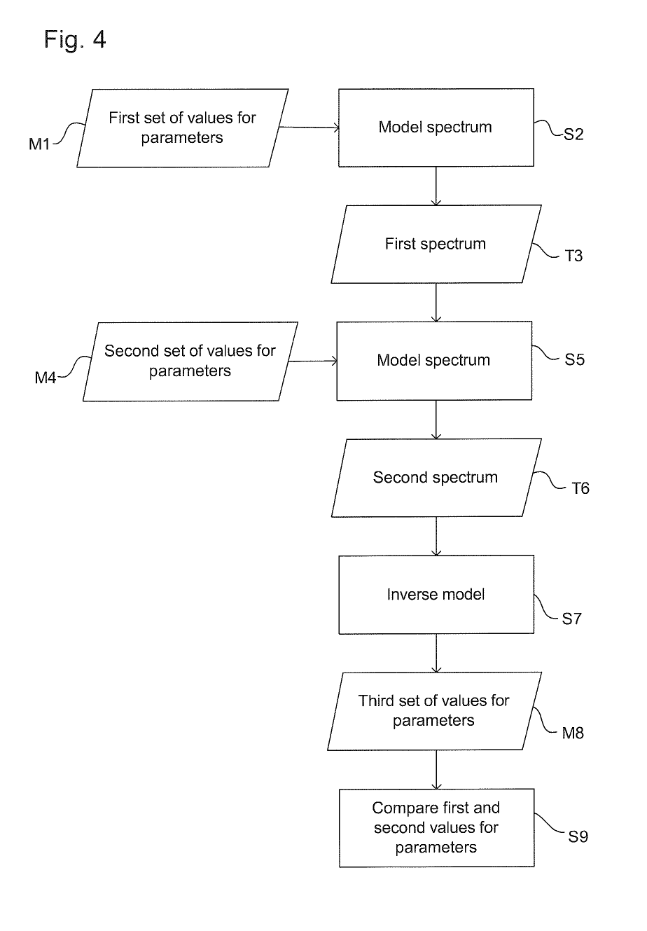

A example modeling technique, disclosed in U.S. Pat. Pub. No. 2009/0094005 (and which is incorporated herein by reference in its entirety), devised predominately to help determine the selection of free and fixed parameters in a particular model, can be used to help determine this measurement accuracy. This modeling technique is now described with reference to FIG. 4. The parameters used in a spectrometer, such as the thickness of layers of the substrate, are measured or estimated by the user. These values are input into a model, S2 of the spectrometer as a first set of values, M1 for the parameters to generate a modeled spectrum, T3.

One or more of the parameters is designated a free parameter and the remaining parameters are fixed parameters, according to an embodiment of the present invention. One of the fixed parameters is changed by a small amount, for example by an amount representative of the variation or error in the determination of the fixed parameter, to form a second set of values, M4 and the model of the spectrometer run again, S5. In an embodiment, this generates a second spectrum, T6 which will differ from the first spectrum.

In an embodiment, an inverse of the model of the spectrometer is then applied, S7 to the second spectrum, with the fixed parameters being the same values as the values from the first set of values, M1. However, as the spectrum differs from the first spectrum the free parameter will differ and thus a third set of values, M8 for the parameters will be generated. The first and third set of values are then compared, S9. If the value for any of the free parameters differs significantly between the first and third set of data, this indicates that the measured values for the free parameters are highly sensitive to errors in the fixed parameters. Thus, even a small error in the estimated or measured value for this fixed parameter would lead to a significant error in the resulting measurement of the free parameters. Thus, if the difference between one or more of the free parameters in the first and third set of data exceeds a predetermined level, the chosen designation of free and fixed parameters is rejected. The same second spectrum can be used to generate further sets of values, each set of values being the same as the first set of values except for the designated free parameters, the set of free parameters which differs being a different set for each set of values.

Using the model the third set of values may be used to generate a spectrum, according to an embodiment of the present invention. This may be compared to the spectrum generated using the first set of values to give a further indication of the merit of selection of free parameters.

In an embodiment, this process is repeated for each of the fixed parameters in relation to all chosen sets of free parameters.

The model of the spectrometer and a given profile may be linearized for small changes in the model parameters. Linearization may drastically increase the speed of generating new spectra and doing the inverse modeling. A true inverse of a model of the spectrometer may often be extremely time consuming so an approximation to an inverse of a model of the spectrometer may be often used in an embodiment, especially an inverse of a linearized version of the model.

The model parameters may include the thickness of layers of the substrate, reflectivity of layers of the substrate, the refractive index and absorption coefficient of materials used and parameters indicating the shape of the measured structure, as well as parameters in the spectrometry model such as the gain of the photon detector.

It is of particular note that two predictions may be made from such a model regarding error contributions on the critical dimension and the sidewall angle. The first concerns in what magnitude errors in the fixed parameters are transferred into errors in the free parameters (and hence in the measurements of the critical dimension and the sidewall angle). The error in the fixed parameter may be estimated if its source is known, this may be due to metrology noise, or process variations. By using the method discussed above, while setting (at least) the critical dimension and the sidewall angle as the free parameters, the impact of errors in the fixed parameters on the critical dimension and the sidewall angle becomes known, according to an embodiment of the present invention.

The second concerns variations in the intensity as seen by detector 4. The source of these variations may be, for example, photon noise or vibrations in the metrology tool and the magnitude of the variations can be determined from repeatability measurements. The modeling method described above then enables calculation of how this noise on the intensity translates into noise on the measured critical dimension and the sidewall angle.

In an embodiment, said uncertainty may be determined in the form of a matrix indicating model calibration and measurement variance and covariance of the parameters of interest. There are a number of options for obtaining this variance and covariance information for the parameters of interest. These include embodiments where:

noise is modeled and then transferred to the parameter of interest domain, using a linearization (e.g., Jacobian matrix);

noise is modeled and via a quadratic or higher order Taylor expansion transferred to the parameter of interest domain; and,

Monte Carlo brute force numerical calculation of the noise in the parameter of interest domain is performed.

The role of the covariance (i.e., uncertainties and correlation thereof) is that it:

allows unbiased maximum likelihood estimation of the parameters of interest;

allows outlier detection and handling; and,

allows computation of the uncertainty and the correlation of the results (e.g., the focus and dose uncertainties and the correlation thereof) as well as the SWA and CD uncertainty and the correlation thereof.

Once the uncertainty (and possibly the covariance or full confidence area) of the measured critical dimension and the sidewall angle is determined, it can be reported in the metrology tool/spectrometer output for each separate target, along with the measured CD and SWA values.

This reported uncertainly/correlation information may then be used in the subsequent stages of focus and dose estimation, in the exposure tool or litho cluster monitoring, and/or exposure tool or litho cluster control. In an embodiment, the aforementioned feedback loop can be optimized using the uncertainty of the focus and dose measurements, and the covariance. For example, the data can be filtered using an optimal low-pass filter. Proper weighting of the measured CD and SWA data in the focus and dose estimation, or proper filtering in the course of monitoring and control may be performed. Also outlier removal and out-of-control detection can be part of the optimization of the subsequent stages.

Furthermore, the use of multiple targets to determine focus and dose more accurately can also be optimized once the uncertainties and correlations of the CD and SWA measurements are known for each particular target. It is a well known rule that in a fitting process, the measurements should be weighted with the signal-to-noise ratio to obtain an unbiased estimation of the fitting parameters.

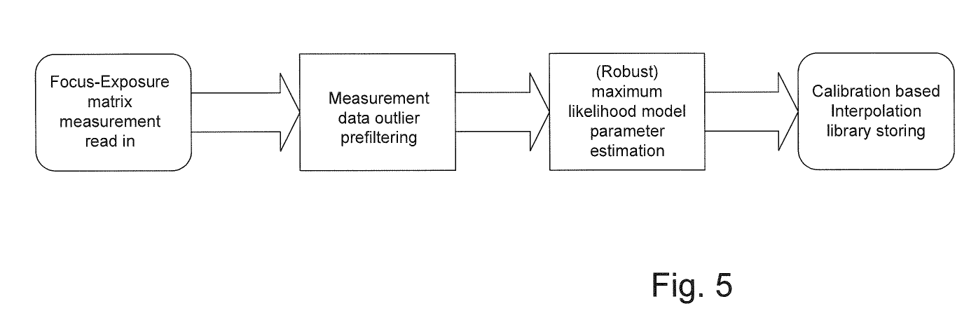

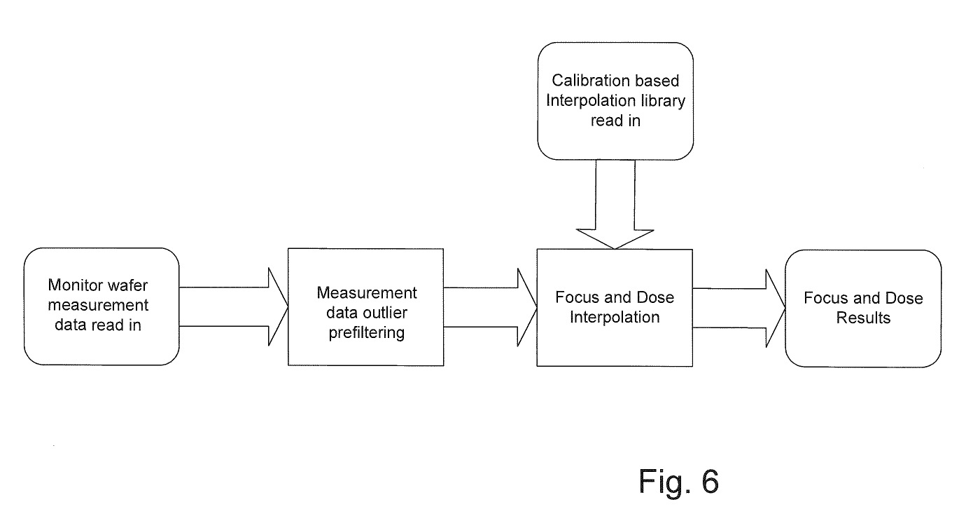

One embodiment for focus and dose separation is described below. The embodiment includes two basic algorithms, a model parameter calibration algorithm as shown in FIG. 5 and a monitor wafer focus and dose inversion algorithm as shown in FIG. 6.

With regard to the model parameter calibration algorithm of FIG. 5, the following identical models are used to model the midCD and SWA in terms of focus and dose (or energy):

$$C D = {\sum }_{n = \{ 0 , 1 , 2 , 3 , 4 \}} {\sum }_{m = \{ 0 , 1 \}} {y}_{m , n} \cdot {( 1 - \frac{{y}_{1}}{E} )}^{m} \cdot {( F - {y}_{2} )}^{n} . \\ S W A = {\sum }_{n = \{ 0 , 1 , 2 , 3 , 4 \}} {\sum }_{m = \{ 0 , 1 \}} {y}_{m , n} \cdot {( 1 - \frac{{y}_{1}}{E} )}^{m} \cdot {( F - {y}_{2} )}^{n} .$$

These models have one drawback in that they require the use of a non-linear optimization routine to perform the estimate of the model parameters. As a non-linear optimization routine, a Gauss-Newton trust region minimization routine is used, as it combines computational efficiency with global convergence (it will converge to a local minimum from any initial starting estimate). As second-order derivatives of the model are analytically cheap to compute, these can be made use of via the minimization routine so as to increase convergence speed.

In order to perform an unbiased estimation of the model parameters, use is made of a maximum likelihood estimation, as maximum likelihood estimation is easy to adapt for non-linear problems. It is also easy to adapt for coping with outliers. In this maximum likelihood estimation, a total least squares alike computation of the measurement noise is used. This knowledge of the measurement noise strength can be used to apply a whitening transformation of the residuals.

In order to make the model parameter estimation robust (i.e., insensitive to outliers) an M-estimator approach is used.

The method according to this embodiment may further comprise performing a uniqueness test to determine whether or not a focus and dose pair returned by the application is a unique solution. Thus, the uniqueness test is used to determine whether or not two different midCD and SWA pairs correspond to one focus and dose pair. The test procedure basically includes of the following steps:

1) Pick an untested search library entry;

2) Find its 24 nearest neighbors; and

3) Test if the differences between predicted focus and dose values (calculated by means of a local linear Taylor series expansion) and the exact focus and dose values (taken from the search library), are sufficiently small.

If not all differences are small, flag all points as non-unique.

If all differences are small, flag all unflagged points as unique.

This procedure is repeated until all points have been flagged.

For computational speed reasons the uniqueness test is not performed real time in the monitor application, but is performed off-line in the calibration applications. The uniqueness test results are stored in a fine grained search library that is an input of the monitor application.

In one example, another test that may be performed is the extrapolating test. The calibration application starts with a measurement data outlier pre-filtering. As a consequence, after this pre-filtering, some focus dose pairs might be completely removed from the resulting focus exposure matrix data. Thus certain parts of the focus dose domain might not be covered during the model calibration as a consequence.

The extrapolating test can comprise of finding the smallest convex polygon that encircles all pre-filtered focus dose pairs. Basically, any focus dose pair that is outside of this envelope will be flagged as extrapolating.

The design decisions for the monitor application are geared towards computational efficiency (i.e., computational speed). Therefore, a very fine grained interpolation library is used in which a re-sampling method is applied (think of re-sampling as a very fast higher order interpolation that is capable of interpolating non-uniform data). Use of a (simpler) nearest neighbor interpolation has been rejected, as its use leads to quantized output data, which is considered to be best avoided. The “interpolation” may be done by means of applying a radial reconstruction filter (low pass filter), where the radial reconstruction filter footprint is chosen to equal three times the metrology tool measurement uncertainty.

The spectrometer may include a data handling unit configured to optimize a model of the spectrometer. The data handling unit may include a readable medium encoded with machine executable instructions configured to optimize the model of the spectrometer.

In one embodiment, the exposure tool is controlled using a module which provides an increased ability to control exposure tools/lithography scanners and scanning functionality (when referring to “scanners,” it should be appreciated that this encompasses all the scan modes and functionality described herein, and other scanning functionalities). Such a scanner stability module leads to an optimized process window for a given feature size and chip application, enabling the continuation the creation of smaller, more advanced chips.

When a lithography system is first installed, it is calibrated to ensure optimal operation. However, over time, system performance parameters will drift. A small amount of drift can be tolerated, but too much drift and the system will go out of specification. Consequently, manufacturers are required to stop production periodically for re-calibration. Calibrating the system more frequently gives a bigger process window, but at the cost of more scheduled downtime.

The scanner stability module greatly reduces these production stoppages. Instead, it automatically drives the system towards a pre-defined baseline on a regular basis (typically every few days). To do this, it retrieves standard measurements taken from one or more monitor wafers using a dedicated metrology tool. The monitor wafer is exposed using a special reticle containing special scatterometry marks. From that day's measurements, the scanner, stability module determines how far the system has drifted from its baseline. It then calculates wafer-level overlay and focus correction sets. The lithography system then converts these correction sets into specific corrections for each exposure on subsequent production wafers.

Where such a scanner stability module is used in combination with a dedicated metrology tool, the metrology tool may provide the accuracy estimator while the scanner stability module receives and uses the estimator in determining focus and dose during exposure. An advantage of the disclosed method, among others, is that the estimator does not have to worry about inferring with the covariance of the output since this will simply be provided. Thus, the estimation of focus/dose can be achieved with fewer measurements, than alternative arrangements which let the estimator in the controller determine the noise level on the CD, SWA measurements.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that embodiments of the present invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens,” where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of embodiments of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present invention should not be limited by any of the above-described exemplary embodiments, but should be defined only in accordance with the following claims and their equivalents.

1. A method comprising:
using a metrology tool to measure a target;
using a model of a metrology tool, the model comprising at least one measurement error source, to determine a measurement error of at least one measured parameter of the target being measured by the metrology tool; and
reporting the value of the at least one parameter, along with the corresponding measurement error determined for the at least one parameter, in the metrology tool output for the target.

2. The method of claim 1, further comprising repeating the using the metrology tool, the using the model, and the reporting for different types of targets, thereby separating effects of focus and dose.

3. The method of claim 1, wherein the measurement error source comprises at least one of detector noise, positioning errors, and numerical errors.

4. The method of claim 1, wherein the at least one measured parameter comprises at least one of a critical dimension and sidewall angle of the target.

5. The method of claim 1, wherein the using the model comprises measuring a misalignment between subsequent exposures.

6. The method of claim 1, wherein the reporting the measurement error comprises reporting at least one of an accuracy, a precision, a variance, and a confidence interval.

7. The method of claim 1, wherein the using the metrology tool comprises measuring a plurality of parameters for each target and wherein the reporting the value comprises reporting at least one of a covariance matrix, a confidence region, and a correlation coefficient.

8. The method of claim 1, wherein the reporting the value comprises using the reported measurement error for optimization of an exposure process.

9. The method of claim 8, wherein the optimization of the exposure process comprises using the reported measurement error for monitoring and control of the exposure process.

10. The method of claim 9, wherein the optimization of the exposure process comprises using the reported measurement error in a calibration of a model of the exposure process.

11. The method of claim 10, wherein the monitoring and the calibration comprise at least one of filtering, weighting, flyer removal, and out-of-control detection of the at least one measured parameter based on the reported measurement error.

12. The method of claim 11, wherein the model of the exposure process comprises a model of at least one of a critical dimension and a sidewall angle as a function of exposure focus and dose.

13. The method of claim 12, wherein the model of the critical dimension and sidewall angle comprises applying a model:
$$= {\sum }_{n} {\sum }_{m} {y}_{m , n} \cdot {( 1 - \frac{{y}_{1}}{E} )}^{m} \cdot {( F - {y}_{2} )}^{n}$$
wherein E is the exposure dose and F is the focus.

14. The method of claim 12, wherein the model of the exposure process comprises a model of at least one of a critical dimension and a sidewall angle of a plurality of different targets as a function of other exposure tool parameters.

15. The method of claim 14, wherein the other exposure tool parameters comprise at least one of numerical aperture (NA), illumination sigma, and polarization.

16. A lithographic system comprising:
an illumination system configured to produce a beam of radiation;
a support device configured to support a patterning device that is capable of patterning the beam of radiation;
a projection system configured to project the patterned beam onto a substrate;
a measurement system configured to:
use a metrology tool to measure a target;
use a model of a metrology tool, the model comprising at least one measurement error source, to determine a measurement error of at least one measured parameter of the target being measured by the metrology tool; and
report the value of the at least one parameter, along with the corresponding measurement error determined for the at least one parameter, in the metrology tool output for the target.

17. An article of manufacture including a computer-readable medium having instructions stored thereon that, when executed by a computing device, cause the computing device to perform operations comprising:
using a metrology tool to measure a target;
using a model of a metrology tool, the model comprising at least one measurement error source, to determine a measurement error of at least one measured parameter of the target being measured by the metrology tool; and
reporting the value of the at least one parameter, along with the corresponding measurement error determined for the at least one parameter, in the metrology tool output for the target.
